(19) United States
(12) Patent Application Publication
(10) Pub. No.: US 2016/0062421 A1
(43) Pub. Date: Mar. 3, 2016

(54) DEVICE SIDE INITIATED THERMAL THROTTLING

(71) Applicant: LENOVO (SINGAPORE) PTE. LTD., Singapore (SG)

(72) Inventors: Takashi Sugawara, Tokyo (JP); Alan Frederick Arnold, Durham, NC (US)

(73) Assignee: LENOVO (SINGAPORE) PTE. LTD., Singapore (SG)

(21) Appl. No.: 14/476,461

(22) Filed: Sep. 3, 2014

(51) Int. Cl. G06F 1/20; G05B 15/02

(52) U.S. Cl. CPC G06F 1/206; G05B 15/02

(57) ABSTRACT

Thermal throttling of a storage device may be provided independent of the host computing device according to the disclosed exemplary embodiments. The storage device may be connectable to more than one type and/or make of host computing devices whose thermal safety requirements may differ. Threshold temperature values for safely operating the storage device may be stored in the host computing device. A controller in the storage device may receive the threshold temperature value(s) from the host computing device and may throttle operating performance of the storage device based on a sensed operating temperature of the storage device compared relative to the stored threshold temperature value associated with the host computing device.

### BACKGROUND OF THE INVENTION

The present invention generally relates to portable electronic devices and, more particularly, to device-side initiated thermal throttling in computing systems.

Some storage devices may be used for different types of computing systems. For example, solid state drives may be connected (either internally or externally) to desktop computers, laptops or notebooks, or other computing systems. Increasing performance capacity in storage devices may cause overheating in some computing systems. Typically, a storage device must satisfy industry standards (for example, Information Technology Equipment Safety specifications of International Electrotechnical Commission (IEC) 60950-1) for safely operating within a host computing system. The thermal criteria for safely operating a storage device may be stored in the storage device itself. Thermal criteria may include, for example, the temperature limits for operating a computing system safely within the industry or manufacturer's standards. When the operating temperature of the storage device reaches a temperature limit, the storage device may be shut down to prevent overheating. As may be appreciated, shutting down the storage device may cause the entire computing system to fail or to perform at a greatly reduced level. In addition, the thermal output of a storage device may vary when operated, for instance, within a desktop computer as compared to operating in a laptop or notebook computer. The tighter environment in a laptop or notebook computer may trap more heat, causing a “hotspot” that may exceed the safe operating temperature.

One approach to controlling the system's temperature may include a host side initiated control using an application in the host computing device to monitor the thermal output of each subsystem device (for example, a storage device) and to control operation of each device subsystem as needed. However, this approach typically involves using software that is not installed in every host computing device and, thus, only works for those systems that have it stored. In addition, this approach relies on the host's temperature monitoring application to work while the operating system (OS) functions. There are times when the OS may become hung-up and thermal monitoring would not occur, allowing the storage device to continue to operate and build up heat beyond safe standards.

As can be seen, there is a need for reliable control of a storage device's thermal output through controlling its performance.

### SUMMARY OF THE INVENTION

In one aspect of the present invention, a computing system comprises a host computing device; a storage device connectable to the host computing device; and a controller in the storage device configured to: read a threshold temperature value from the host computing device; and maintain an operating temperature of the storage device below the threshold temperature value.

In another aspect of the present invention, a storage device, comprises a memory device; a temperature sensor; and a controller configured to: throttle an amount of operating performance in the memory device based on a relationship of a detected temperature of the storage device to a threshold temperature value of the host computing device.

In another aspect of the present invention, a method of reducing the thermal output of a storage device in a host computing device comprises sending to the storage device, one or more threshold temperature values stored in a BIOS of the host computing device; reading a current operating temperature of the storage device; determining whether the current operating temperature of the storage device exceeds the one or more threshold temperature values; and determining an amount of operating performance throttling of the storage device in response to the current operating temperature of the storage device exceeding the one or more threshold temperature values.

These and other features, aspects and advantages of the present invention will become better understood with reference to the following drawings, description and claims.

### BRIEF DESCRIPTION OF THE DRAWINGS

FIG. 1 is a block diagram of a computing system in accordance with an exemplary embodiment of the present invention;

FIG. 2 is a flow chart of a method of throttling thermal output of a storage device in accordance with an exemplary embodiment of the present invention;

FIG. 3 is a plot of operating performance and thermal throttling and temperature of a storage device in accordance with an exemplary embodiment of the present invention; and

FIG. 4 is a performance comparison of test results showing operating performance output of a storage device using exemplary embodiments of the present invention compared to performance output of storage devices in the prior art.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Furthermore, one or more of the problems discussed above may not be fully addressed by any of the features described below.

Exemplary embodiments of the present invention generally provide thermal throttling of a storage device. The storage device may control thermal throttling (device side initiated throttling) as opposed to a host side controlling the throttling. The thermal throttling may be controlled based on information stored in a host computing device connected to the storage device. The storage device may throttle itself to operate at higher or lower operating performance depending on thermal criteria associated with the host computing device in order to avoid operating temperatures exceeding safety standards and to maximize operating uptime of the storage device.

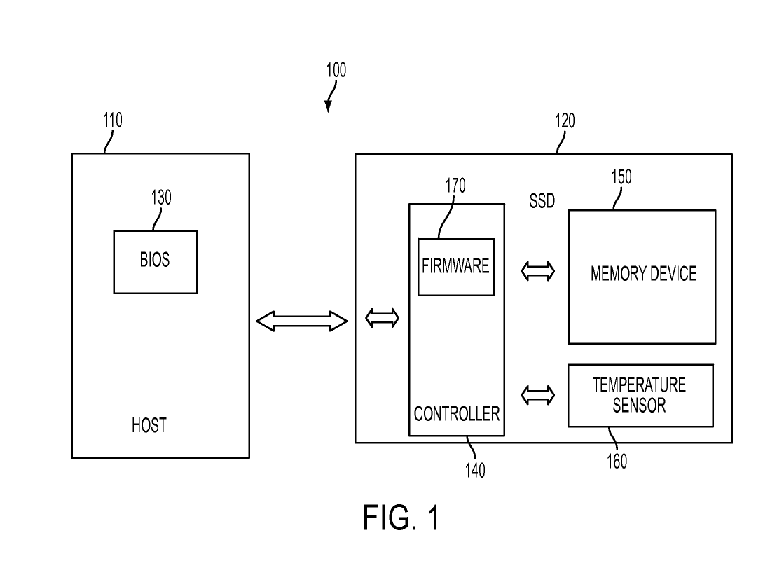

Referring to FIG. 1, a computing system 100 (referred to generally as the system 100) is shown according to an exemplary embodiment of the present invention. The system 100 may generally include a host computing device 110 and a data storage device 120. In some embodiments, the data storage device 120 may be removably connected to the host computing device 110. The host computing device 110 may be, for example, a desktop computer, a laptop or notebook type portable computer, or a tablet device. The operating performance of the data storage device 120 may be controlled according to thermal criteria stored in the host computing device 110. In an exemplary embodiment, the data storage device 120 may be a solid state drive. It is known that solid state drives may create a “hot spot” in some host computing devices 110, for example, laptops when the solid state drive is operated under heavy workloads. A “hot spot” may result in the laptop overheating or injury to the user and may present a dangerous situation. However, it will be appreciated that exemplary embodiments of the present invention may provide controlled operation of, for example, a solid state drive depending on the type or make of the host computing device 110 as discussed in the detail that follows.

The host computing device 110 may include a BIOS 130. The BIOS 130 may include information related to the host computing device 110. The BIOS 130 may include, in its boot files, a safe operating temperature associated with the host computing device 110. Different desktop computers or different laptop computers (host computing devices 110) may have varying operating temperature requirements within their respective device type. Thus, the safe operating temperature stored in the BIOS 130 may depend on the make of the host computing device 110. In an exemplary embodiment, the safe operating temperature may be read by the data storage device 120 and used to control operating performance so that the performance of the storage device 120 is throttled to avoid overheating.

The storage device 120 may include a controller 140, a memory device 150, and a temperature sensor 160. The controller 140 may include firmware 170 with computer executable instructions controlling the operating performance of the data storage device 120. For example, the firmware 170 may receive a current operating temperature of the data storage device 120 detected by the temperature sensor 160. In some embodiments, the firmware 170 may include preset thermal throttling criteria for operation of the data storage device 120. In an exemplary embodiment, the firmware 170 may change the thermal throttling criteria by reading the BIOS 130 to obtain the safe operating temperature associated with the host computing device 110. The safe operating temperature associated with the host computing device 110 may be considered a threshold temperature value in determining whether the operating performance of the data storage device 120 should be increased, maintained, or reduced. The firmware 170 may compare the detected current operating temperature of the data storage device 120 to the threshold temperature value associated with the host computing device 110. The firmware 170 may control operating performance in the data storage device 120 to maintain an operating temperature of the data storage device 120 below the threshold temperature value. If the firmware 170 determines that the detected current operating temperature of the data storage device 120 exceeds the threshold temperature value, then the firmware 170 may direct the controller 140 to throttle operating performance of the data storage device 120. The controller 140 may be configured to control operating performance of the storage device 120, for example, by adjusting the amount of read/write operations performed by the memory device 150 over time (for example, in MB/s). The controller 140 may reduce the amount of read/write operations in the data storage device 120 to throttle down the operating temperature.

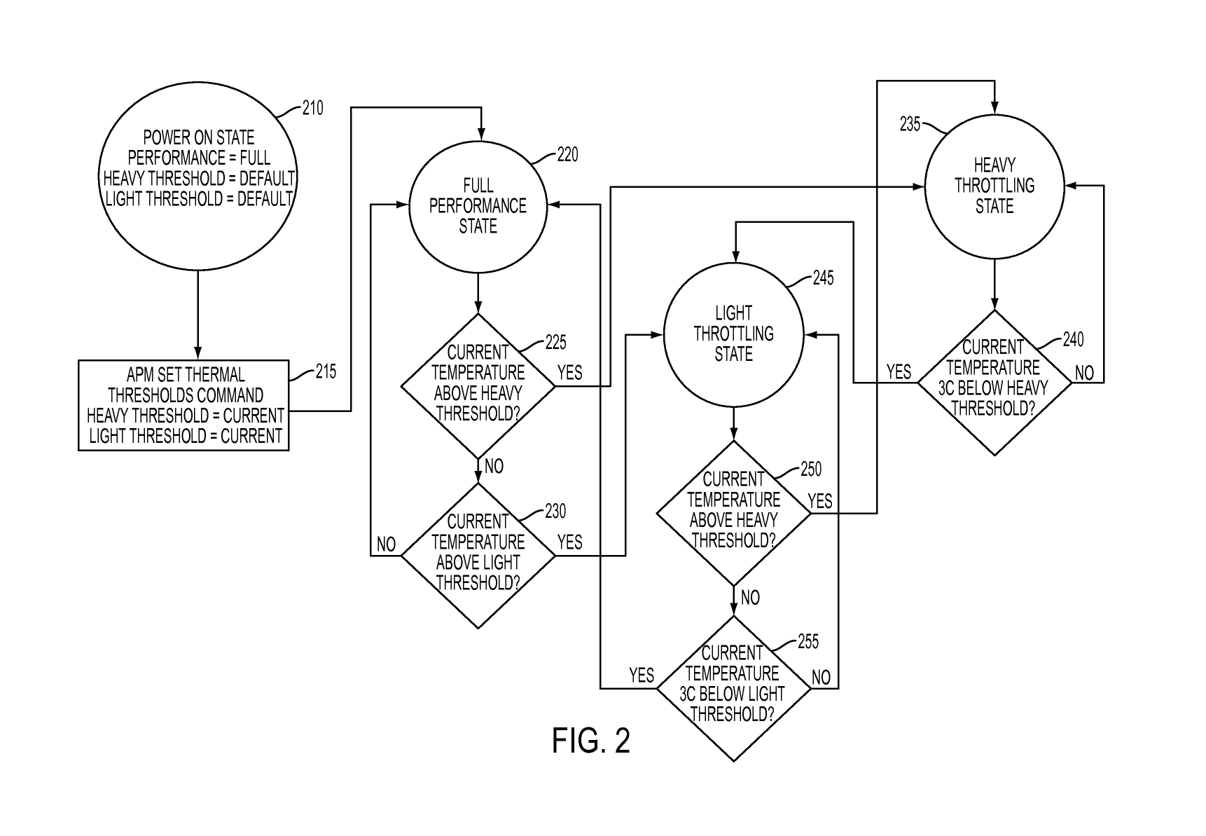

Referring now to FIG. 2, a method 200 of throttling thermal output of a storage device in a host computing device is shown according to an exemplary embodiment of the present invention. References to elements in the blocks below may be performed, for example, by like elements described in FIG. 1. In an exemplary embodiment, the storage device may be throttled down according two different levels of operating performance depending on the detected temperature of the data storage device: a light throttling state and a heavy throttling state.

For example, in block 210, the system may power on. If the host computing device does not include thermal criteria for thermal throttling the storage device may be set by default to operate at full speed capability. The storage device may, by default, set light throttling to occur at a first temperature threshold value. The storage device may also by default set heavy throttling to occur at a second temperature threshold value. In block 215, a pre-defined command from the host computing device, may set the first temperature threshold value for light throttling and the second temperature threshold value for heavy throttling.

In block 220, the storage device may operate at full performance capability. In block 225, a controller in the storage device may determine whether a detected current temperature of the storage device is above the temperature threshold value for heavy throttling. If the temperature threshold value for heavy throttling is exceeded, then in block 235, the storage device may be operated under heavy throttling. Heavy throttling may be, for example, operating at approximately 5%-10% of full operating performance. The storage device may be operated under heavy throttling until the detected current temperature of the storage device drops by a predetermined amount, for example, by 3° C. (block 240), at which point, the storage device may be operated under light throttling in block 245. Light throttling may be, for example, approximately 50% of full operating performance.

If the determination in block 225 resulted in the detected current temperature of the storage device not exceeding the temperature threshold value for heavy throttling, then, in block 230, the controller may determine whether the detected current temperature of the storage device exceeds the temperature threshold value for light throttling. If the temperature threshold value for light throttling is not exceeded, then the method reverts back to block 220 and the storage device may continue to operate at full performance.

If the determination in block 230 results in the temperature threshold value for light throttling being exceeded, then in block 245, the storage device may be operated under light throttling. In block 250, the controller may determine whether, under light throttling, the current temperature of the storage device has exceeded the temperature threshold value for heavy throttling. If the temperature threshold value for heavy throttling has been exceeded, the storage device may be operated under heavy throttling as described earlier in blocks 235 and 240.

If the temperature threshold value for heavy throttling has not been exceeded in block 250, then the controller may determine in block 255 whether the current operating temperature of the storage device has dropped by a predetermined amount, for example, by 3° C. at which point, the storage device may be operated at full operating performance (block 220).

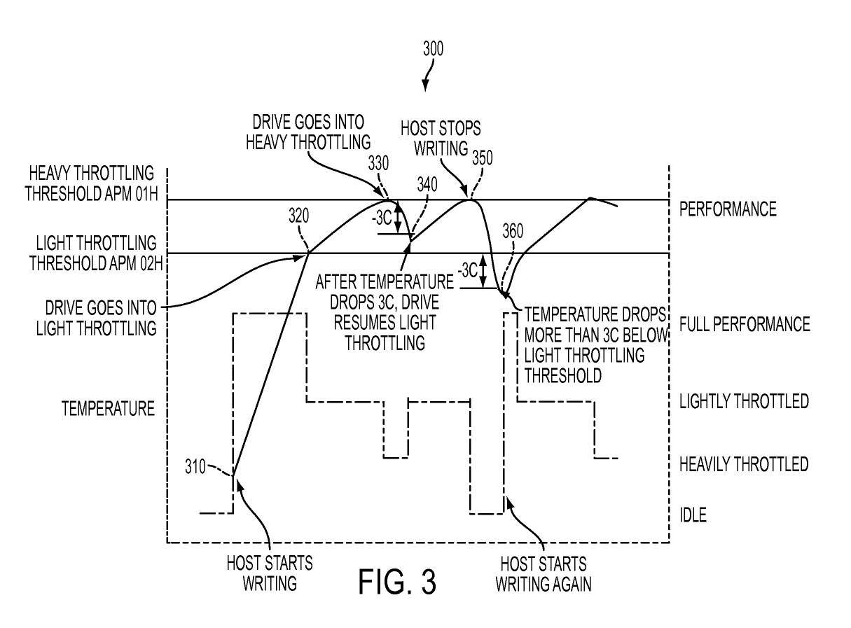

Referring to FIG. 3 (with concurrent reference to elements of FIG. 1), a plot 300 is shown according to an exemplary embodiment of the present invention. The plot 300 illustrates an exemplary operating performance (represented by the dashed plot) of the data storage device 120 and temperature (represented by the solid plot) corresponding to operating performance over time. The operating performance is shown throttled according to threshold temperature values associated with the host computing device 110. At point 310, the host computing device 110 may begin writing to the data storage device 120. As the operating performance reaches full performance capacity, the temperature may increase. At point 320, the data storage device 120 may have been operating at full performance for some arbitrary amount of time and the current temperature of the data storage device may have exceeded the threshold temperature value for light throttling. The data storage device 120 may thus be operated under light throttling; however, as seen at point 330, the temperature of the data storage device may in some cases continue to increase even under light throttling until the threshold temperature value for heavy throttling is reached or exceeded. The data storage device 120 may be throttled down further from light throttling to operate under heavy throttling until the operating temperature of the data storage device drops by, for example, 3° C. (point 340) in which case, light throttling of the data storage device may resume. In the event that the operating temperature of the data storage device resumes increasing under light throttling, at point 350, the host computing device 110 may stop writing until the operating temperature of the data storage device drops by, for example, 3° C. below the threshold temperature value for light throttling (point 360). At point 360, the host computing device 110 may resume writing and the controller 140 may operate at full performance based on the operating temperature of the data storage device 120 being below both the light and heavy threshold temperature values.

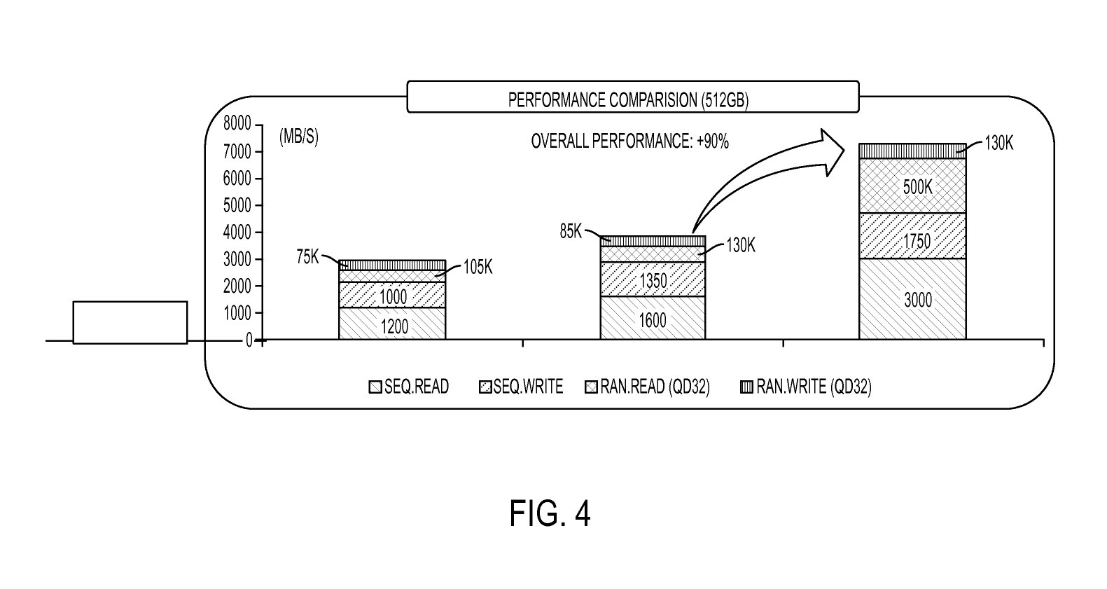

Referring to FIG. 4, test results of a performance comparison are shown demonstrating unexpected and significantly higher performances of a storage device (on the far right) using aspects of the present invention compared to two storage devices (far left and center) that do not use the aspects of the disclosed present invention. As may be appreciated, the storage device using aspects of the present invention exhibited nearly double (90% more) the operating performance output of the storage drive shown in the center. This increased operating output may be attributed to the fact that storage devices using the disclosed aspects of the present invention may continue to operate at reduced performance rather than shut down entirely once temperature thresholds are exceeded.

It should be understood, of course, that the foregoing relates to exemplary embodiments of the invention and that modifications may be made without departing from the spirit and scope of the invention as set forth in the following claims.

What is claimed is:

1. A computing system, comprising:
a host computing device;
a storage device connectable to the host computing device; and
a controller in the storage device configured to:
read a threshold temperature value in the host computing device;
and
maintain an operating temperature of the storage device below the threshold temperature value.

2. The computing system of claim 1, wherein the storage device is a solid state drive (SSD).

3. The computing system of claim 1, further comprising a temperature sensor in the storage device, wherein the controller is configured to:
read a current operating temperature of the storage device, and
determine whether the current operating temperature of the storage device exceeds the threshold temperature value.

4. The computing system of claim 3, wherein the operating performance of the storage device is the number of read/write operations performed by the storage device per unit of time.

5. The computing system of claim 4, wherein the controller is configured to reduce the number of read/write operations performed by the storage device per unit of time until the current operating temperature of the storage device is below the threshold temperature value.

6. The computing system of claim 1, wherein the threshold temperature value is dependent on a device type associated with the host computing device.

7. The computing system of claim 1, wherein control of the operating performance in the storage device is variable based on a thermal criteria associated with a device make of the host computing device.

8. A storage device, comprising:
a memory device;
a temperature sensor; and
a controller configured to:
throttle an amount of operating performance in the memory device based on a relationship of a detected temperature of the storage device to a threshold temperature value of the host computing device.

9. The storage device of claim 8, wherein the storage device is a solid state drive (SSD).

10. The storage device of claim 8, wherein the threshold temperature value is read from a BIOS of the host computing device.

11. The storage device of claim 8, wherein the operating performance of the storage device is the number of read/write operations performed by the storage device per unit of time.

12. The storage device of claim 8, wherein throttling the amount of operating performance in the memory device includes reducing read/write operations performed by the memory device until the detected temperature of the storage device is below the threshold temperature value.

13. The storage device of claim 8, wherein the threshold temperature value is variable dependent on the type of host computing device from which the threshold temperature value is read.

14. The storage device of claim 13, further comprising firmware in the controller, the firmware configured to:
determine whether the detected temperature of the storage device provided by the temperature sensor exceeds the threshold temperature value, and
throttle down operating performance in the memory device in response to the detected temperature exceeding the threshold temperature value.

15. A method of throttling thermal output of a storage device in a host computing device, comprising:
sending to the storage device, one or more threshold temperature values stored in a BIOS of the host computing device;
reading a current operating temperature of the storage device;
determining whether the current operating temperature of the storage device exceeds the one or more threshold temperature values; and
determining an amount of operating performance throttling of the storage device in response to the current operating temperature of the storage device exceeding the one or more threshold temperature values.

16. The method of claim 15, further comprising:
setting a first threshold temperature value for a first amount of operating performance throttling; and
setting a second threshold temperature value for a second amount of operating performance throttling.

17. The method of claim 16, further comprising:
operating the storage device according to the first amount of operating performance throttling in response to the current operating temperature exceeding the first threshold temperature value.

18. The method of claim 17, further comprising:
operating the storage device according to the second amount of operating performance throttling in response to the current operating temperature exceeding the second threshold temperature value.

19. The method of claim 18, wherein the second amount of operating performance throttling reduces operating performance of the storage device more than the first amount of performance throttling.

20. The method of claim 15, wherein the storage device is a solid state drive.
